(19) United States
(12) Patent Application Publication
(10) Pub. No.: US 2014/0234205 A1
(43) Pub. Date: Aug. 21, 2014

(54) METHOD AND DEVICE FOR PREPARATION OF HYDROGEN SUITABLE FOR CIVIL APPLICATIONS, AND COMPOSITION

(71) Applicant: Ke Jin, Shanghai (CN)

(72) Inventor: Ke Jin, Shanghai (CN)

(21) Appl. No.: 14/346,514

(22) PCT Filed: Nov. 2, 2012
(86) PCT No.: PCT/CN2012/084001

§ 371 Date: Mar. 21, 2014

(30) Foreign Application Priority Data
Nov. 23, 2011 (CN) 201110379393.8
Mar. 19, 2012 (CN) 201210089383.5

(51) Int. Cl. C01B 3/08

(52) U.S. Cl. CPC C01B 3/08
USPC 423/657; 252/188.25; 422/162

(57) ABSTRACT

Disclosed is a method for the preparation of hydrogen suitable for civil applications, in which metal aluminum is mainly used for producing hydrogen. Water is added into a collection of reactants formed by placing an alkaline substance and metal aluminum together. The portion of said alkaline substance or its reaction product with water, wherein participates in the mass-transferring contact with said metal aluminum, has an effective molar ratio of less than 0.8 with respect to said metal aluminum. The water is added slowly into the collection of reactants; during the reaction, residual reactive but as yet unreacted water has a molar ratio of less than 1 but greater than 0 with respect to the metal aluminum added initially. Also disclosed is a device for the preparation of hydrogen, and a composition.

### TECHNOLOGY FIELD

The present invention specifically relates to a method and device for preparation of hydrogen suitable for civil applications, and a composition.

### BACKGROUND OF THE INVENTION

Hydrogen is a new energy with good prospects. But the high density storage of hydrogen involves quite many bottlenecks. Another method is chemically preparing hydrogen on the spot to fulfil application demands.

Preparing hydrogen with the chemical reaction of metal hydrides, provides high energy density, such as LiH+H₂O═LiOH+H₂, NaBH₄+4H₂O═NaB(OH)₄+4H₂. But metal hydrides are typically quite expensive and toxic, and thus are only suitable for military application, not civil.

Metal aluminum has the potential to react with water and produce hydrogen; Since aluminum is cheap and non-toxic, with theoretically quite high hydrogen weight density, so scientific community's attention is attracted. But aluminum can't simply react with water continuously; The possible reason is a dense protection layer on the surface of aluminum formed by initial reaction product.

A background technology is putting aluminum into strong alkaline solution, Al+3H₂O+NaOH═NaAl(OH)₄+1.5H₂. Since NaOH has a quite great molar mass, even beyond aluminum itself, so the hydrogen weight density is greatly reduced.

Or otherwise, putting aluminum into strong acid solution, such as Al+3HCl═AlCl₃+1.5H₂, as well 2Al+3H₂SO₄═Al₂(SO₄)₃+3H₂. Some strong acid, such as HCl, is quite volatile, and will be bring out with hydrogen flow, damages the gas pipeline and hydrogen application device, pollutes the environment. Some strong acid, such as H₂SO₄, is less volatile, but with great molar mass, so the hydrogen weight density is greatly reduced.

Another background technology uses low-melting-point metal, such as mercury, covers the aluminum surface with aluminum-mercury alloy, and may help to damage the dense protection layer on aluminum surface, ensures the continuous reaction between aluminum and water. But mercury is toxic, its vapor is hypertoxic, the mercuric chloride or mercuric nitrate for preparing aluminum-mercury alloy is hypertoxic too.

Several years before, an American scholar used another low-melting-point metal, gallium, which is nontoxic, formed alloy with aluminum, and functioned similar to mercury. But the content of gallium in alloy is 20%; the market price of gallium is about 100 times to aluminum, so the cost of hydrogen preparation is greatly increased.

U.S. Pat. No. 6,969,417 provides an alloy which can decompose water into hydrogen and oxygen when contacting water, comprising aluminum, sodium, lead and (platinum), wherein the weight ratio of sodium to aluminum is preferred as 5:1.

U.S. Pat. No. 6,899,862, injects the water solution of sodium hydroxide into a reactor and contact the substance comprising aluminum, adjusts the liquid level of solution, adjusts the injection rate of solution, or draws out the solution from the reactor, thereby controls the reaction process.

Chinese patent 200880001156.4, originally from Korea by PCT, provides a composition which can produce hydrogen while contacting water, wherein comprises 100 portion by weight of aluminum powder, 80˜150 portion by weight of calcium oxide powder or dolomite powder, 5˜20 portion by weight of sodium hydroxide powder. Also disclosed is that, if the calcium oxide is less than 80 portion by weight, the controlling of reaction speed will be difficult; if the calcium oxide is more than 150 portion by weight, the reaction speed will be too slow.

Chinese patent 201110240844.X (published on 18 Jan. 2012), with the same inventor of said Korea patent, pointed out that, the said technology can produce large amounts of hydrogen in short term, but need tank and device to store hydrogen, the volume and weight of device is great, thus not portable. 201110240844.X also provided a small power generator using the composition and a portable high-polymer fuel cell; In order not to make the reaction violent, the composition comprises granules of diameter 1˜5 mm including aluminum; The reaction chamber (7) comprises the composition (6), the composition (6) is immerged in water (5).

American patent 20070020174, contact aluminum and reaction promoter in the presence of an aqueous liquid, under appropriate reaction conditions, wherein the relative amounts of the reaction materials and the aqueous liquid are selected such that the pH of the aqueous product is less than about 12. It uses low weight ratio of NaOH, CaH₂, CaO or KOH to mix with aluminum, adds water far more than enough, uses magnetic stir bar and heating, some of the examples get a hydrogen yield of about 85% of the theoretical hydrogen yield.

### CONTENTS OF THE INVENTION

The purpose of present invention is to overcome the low hydrogen weight density, toxicity to environment or high cost of existing technology for preparing hydrogen; and provides a method and device for preparation of hydrogen suitable for civil applications, and a composition. The method of present invention provides high yield percentage, high hydrogen weigh density, low cost and environmentally friendly, thus suitable for civil application.

After large amounts of research, considering and analysis, the present inventor believes:

The background American patent 20070020174 mixes low weight ratio of hydride or hydroxide or oxide, of alkali metal or alkali earth metal, with aluminum, then adds water to produce hydrogen. But hydrides are all toxic and strong corrosive; the hydroxides and oxides of alkali metal are all strong corrosive; In alkali metal oxides, Li₂O is expensive, Na₂O and K₂O are difficult to produce, or even get hyperoxides which are quite heavy and release oxygen when contacting water, oxygen is dangerous in hydrogen environment; the hydroxides and oxides of alkali earth metal are less corrosive and relatively safe, but with worse performances and quite more weight ratio needed, thus not good to improve energy density.

The composition of alkali metal hydroxide and aluminum reacts too violent while contacting water; Even though the weight ratio of hydroxide is less, it's still difficult to react steadily with controlled adding of a little water.

The background Chinese patent 200880001156.4 and 201110240844.X take 3 measures to solve this problem: 1, add large amounts of CaO; 2, form large diameter composition ball to reduce the contacting area; 3, immerge in over amount of water, thereby dilute the concentration of hydroxide, increase the heat capacity of system, so as to prevent quick temperature rise. Measure 1 and measure 3 greatly sacrifice the energy density; measure 3 is inconvenient to stop reaction automatically in need and thus decreases the practicability.

American patent 20070020174 uses over amount of water to solve said problem, uses magnetic stir bar and so on to improve hydrogen yield. These 2 measures also greatly sacrifice the energy density, as well are inconvenient to stop reaction automatically in need and decrease the practicability.

The contrasting example 2 of present invention tested the case of using alkali metal hydroxide; the reactor enclosure had to been immerged in water to limit the temperature rise, so as to prevent burning through.

In order to solve said technology problems, the present invention provides following technology solutions:

The present invention firstly provides a composition, wherein it comprises alkaline substance and metal aluminum; Wherein, said alkaline substance is alkali metal, alloy or the salt of alkali metal and weak acid, the effective molar ratio of the alkaline substance with respect to the metal aluminum is less than 0.8, but greater than 0; Said effective molar ratio, is calculated with the hydroxy ion produced by the alkaline substance or its reaction product with water while solving in enough water, with respect to the metal aluminum; Said alkali metal is Li, Na or K; Said alloy is Li alloy, Na alloy or K alloy.

In the hereinafter provided hydrogen preparation method of the present invention, said composition is just right applied to prepare hydrogen, thereby solves the technology problem targeted by the present invention, and achieves the positive improvements of the present invention.

Said alkaline substance of the present invention, is the substance capable of solving in water and producing hydroxy ion, or the substance capable of reacting with water wherein the reaction product is capable of solving in water and producing hydroxy ion.

In the present invention, said weak acid is preferred with a pKa on 25° C. greater than 11.00, (in case of more than one pKa, the greatest one is the criterion). The upper limitation of said pKa is the foregone theoretical upper limitation of weak acid. For example, meta-aluminic acid (pKa=12.20), meta-silicic acid (pKa=11.80), ortho-silicic acid (H₄SiO₄), ortho-boric acid (H₃BO₃).

In the present invention, said alloy is preferred as Li, Na or K formed with metal aluminum. In said alloy, the molar ratio of Li, Na or K with respect to metal aluminum is optionally ranging from 3:1 to 1:3, preferred ranging from 2:1 to 1:2, (such as 1:1). The diameter of said alloy is optionally less than 1 mm, while the lower limitation is the technology limitation of manufacturing.

In the present invention, said effective molar ratio of the alkaline substance with respect to the metal aluminum is preferred as less than 0.8, but greater than 0.001; further preferred as greater than 0.003, but less than 0.8; further preferred as greater than 0.003, but less than 0.4; further preferred as greater than 0.01, but less than 0.4.

In the present invention, said metal aluminum is preferred as granular, with average diameter less than 1 mm; further preferred with average diameter less than 0.1 mm, while the lower limitation is the technology limitation of manufacturing, such as maybe 10 nm so far. While applied in the hydrogen preparing method of present invention, this is helpful to improve the reaction rate, quickly consume the water added and produce hydrogen.

In the present invention, said composition is in the format of unitized composition before the mixing of components, or in the format after mixing. The composition of present invention may also comprise a little water, or the reaction product of water, alkaline substance and metal aluminum. For example, the alkaline substance way in some case absorb moisture; then, a little water may react with alkaline substance and metal aluminum to form a composition, wherein comprises alkaline substance, metal aluminum and said reaction product; this composition is certainly also covered by the composition of present invention.

The present invention further provides a method for the preparation of hydrogen, suitable for civil applications, in which metal aluminum is mainly used for producing hydrogen.

In said method, water is added into a collection of reactants formed by placing alkaline substance and metal aluminum together. The types of said alkaline substance and metal aluminum are same to those mentioned hereinbefore. Said collection of reactants is preferred as said composition; the types, molar ratios and preferred conditions of the components in the composition are same to those mentioned hereinbefore. The collection of reactants will not react by self without water, thus way be stored and carried for long term, with high energy density. Water is easy to be obtained in most of the cases; in civil environment, convenient stores provide drinking water; in military environment, river water, rain, dew and urine can be transferred to clean water by professional filter.

In said method, the portion of said alkaline substance or its reaction product with water, wherein participates in the mass-transferring contact with said metal aluminum, has an effective molar ratio of less than 0.8 with respect to said metal aluminum; preferred less than 0.8, but greater than 0.001; further preferred greater than 0.003, but less than 0.8; further preferred greater than 0.003, but less than 0.4; further preferred greater than 0.01, but less than 0.4. Said effective molar ratio, is calculated with the hydroxy ion produced by the alkaline substance or its reaction product with water while solving in enough water. Said mass-transferring contact, means close enough in distance for chemical reaction. The less dosage of alkaline substance brings many advantages: firstly reducing the cost; secondary reducing the weight and improving the hydrogen weight density; as well, in case of leakage and contacting over amount of water, a little alkaline substance will be fully diluted, and the rate of producing flammable hydrogen is greatly reduced, so that hydrogen is easy to escape in time before reach dangerous concentration; also, the corruption to environment is greatly reduced.

While the collection of reactants formed by placing alkaline substance and metal aluminum together in said method is the composition mentioned above, the type and molar ratio of each component need only fulfil the conditions of said composition, no need to calculate the effective molar ratio of the portion participates in mass-transferring contact with respect to the metal aluminum. It is just right because of this specially selected composition, thereof cooperating with other conditions in said method, the technology problems targeted by the present invention are solved better.

In said method, said water is slowly added into said collection of reactants; During the reaction, residual reactive but as yet unreacted water has a molar ratio of less than 1 with respect to the metal aluminum added initially; wherein preferred to less than 0.5, further preferred to less than 0.3. This point is very critical, since if the water is added too quickly, the alkaline substance will be greatly diluted to a low concentration, thus decreases the reaction rate and can't consume the newly added water in time, thereby accumulates more and more water to a vicious cycle. Too much water also results in the continuous slow reaction after stopping adding water, which produces too much hydrogen; the too great time delay of system control reduces the practicability. The once again 8 hours suspension of reaction in the example 2 of the invention means, if the system stands by for a long term and then restart intermittent working, because of the very short running time, residual reactive but as yet unreacted water has not been accumulated and is very little, so the theoretical lower limitation is greater than 0.

Said residual reactive but as yet unreacted water, is defined as the water capable of keeping react with said collection of reactants and produce hydrogen, if stops adding water to the collection of reactants; thus doesn't include the water distant to the metal aluminum and so difficult to contact and react with the metal aluminum through mass-transferring diffusion, such as the water in water pipeline; Neither includes the water already crystallized or able to crystallize in concentrating or cooling process, thus can't react with the metal aluminum, such as the crystal water of some hydroxides. A method for measuring said residual reactive but as yet unreacted water, is to stop adding water to the collection of reactants, then to collect the hydrogen produced by reaction till no more hydrogen is produced, then to record the hydrogen volume; According to the equation Al+3H₂O═Al(OH)₃+1.5H₂, the result will be calculated out.

In said collection of reactants formed by placing alkaline substance and metal aluminum together of the method, said alkaline substance and said metal aluminum may be placed in a common fluid channel; Respect to the fluid flow direction, the alkaline substance is placed in the upper reaches, the metal aluminum is placed in the lower reaches.

In said method, a flexible material may be filled in a reactor together with said collection of reactants; said flexible material prefers to surround the collection of reactants cylindrically. One function thereof is to absorb the dimension expansion of the collection of reactants during reaction, thereby to prevent the reactor enclosure from damaging. Another function is to prevent the collection of reactants from over densifying, while its dimension expansion is limited by the reactor enclosure, which will make it difficult to the flow and diffusion of water, solution of alkaline substance and hydrogen. Said flexible material, means the material capable of contraction and distortion under stress, such as foamed plastics, foamed silica gel, prefers to polypropylene foamed plastic.

Polypropylene foamed plastic is light weight, hydrophobic, corrosion resistant, heat-stable, environmentally friendly, suitable on hardness, and thus is a preference for the flexible material. But it is not suitable to be rolled up to cylindrical shape from sheet shape, except using tooling to form cylindrical shape. In other case using small ball shape to mix into the collection of reactants, the small ball should be small enough to averagely mix. The ball diameter 0.5 mm is already commercially available for polystyrene foamed plastic; but for polypropylene foamed plastic, because of commercial reason instead of technical reason, only diameter 3 mm instead of 0.5 mm is available, and is normally formed by tooling to various shapes for packaging material of home appliance. In order to solve this problem, the inventor uses kitchen planer tool, cuts the packaging material of home appliance, gets diameter 0.2-1 mm granules of polypropylene foamed plastic.

The inventor believes, in the method of hydrogen preparation in the present invention, low ratio of salt of alkali metal and weak acid or alloy of alkali metal and aluminum to metal aluminum, together with the slow and controlled adding water, the combination of these 2 features is the best and perfect combination. This ensures the stable reaction in the beginning, as well the full reaction to the end (the best example 2 gets a hydrogen yield of more than 90%); it's convenient to stop reaction on demand and thus is well practicable, as well greatly improved the energy density. Since the water is step by step added in during operation process, so in case of providing hydrogen to fuel cell application, it's convenient to recycle the water produced by fuel cell, thereby reduce the water carried.

The salt of alkali metal and weak acid is safe and environmentally friendly, greatly better than the hydroxide of alkali metal; the alloy of alkali metal and aluminum is not corruptive before contacting water, and form meta-aluminum salt immediately while contacting water, the time while the hydroxide thereof existing is extremely short, so it's safe and environmentally friendly too. Thus the production, storage and transportation of the collection of reactants are easier to get government permission, and are more responsible to the end customer of civil market.

According to the experiments, the method of hydrogen preparation, disclosed by the present invention, is advantaged as simple system, controlled reaction and convenient using.

The present invention further provides a reactor; said reactor comprises the composition mentioned hereinbefore in the present invention. Wherein the components, molar ratios and preferred conditions are same to those mentioned hereinbefore.

Said reactor better further comprises a flexible material, which is placed in the reactor together with the composition. Said composition is better surrounded by said flexible material, such as cylindrically. The types of said flexible material are same to those mentioned hereinbefore.

In said reactor, the alkaline substance and the metal aluminum in said composition may be placed in a common fluid channel; Respect to the fluid flow direction, the alkaline substance is placed in the upper reaches, the metal aluminum is placed in the lower reaches. In this case, the reactor may comprise 2 solid vessels joining each other, which comprise the alkaline substance and metal aluminum of said composition respectively; Respect to the fluid flow direction, the solid vessel comprising alkaline substance is placed in the upper reaches, the solid vessel comprising metal aluminum is placed in the lower reaches.

Said reactor may be equipped with a dismountable connecter, which can be used to join the matching connector from other device; such as other solid vessel, which may be dismounted by said connector.

Said reactor may be equipped with a fluid inlet, which can accept fluid to flow into the reactor.

The present invention further provides a reaction device for the preparation of hydrogen, wherein comprises said reactor and a liquid vessel; the reactor and the liquid vessel connect each other, the liquid vessel contains water.

Said reaction device is specially designed to work in with the hydrogen preparation method of present invention. The water from the liquid vessel flow into the reactor, and reacts with the composition of present invention, thereby produces hydrogen; achieves the hydrogen preparation method of present invention.

Said reactor and said liquid vessel are better connected through a liquid pump. Said liquid pump is volume type or momentum type, prefers volume type, further prefers peristaltic pump. By the selection of liquid pump, the flow rate of aqueous liquid from liquid vessel to reactor is controlled.

In the reaction device of present invention, between the reactor and liquid vessel, or between the reactor and liquid pump, may be joined by the dismountable connector on the reactor.

Complying with the general knowledge of this field, said preferred conditions may be mixed in any combination, and get better examples of the present invention.

The reagents and materials of the present invention are all commercially available.

The present invention has positive improvements in overcoming the problems of high costs or toxicity in existing hydrogen production technology of high energy density, and thus is suitable for civil applications.

### BRIEF DESCRIPTION OF THE DRAWINGS

FIG. 1 presents the device for hydrogen preparation in specific embodiments, wherein 1 is liquid vessel, 2 is liquid pump, 3 is reactor; the direction of arrow presents the fluid flow and hydrogen output.

### SPECIFIC EMBODIMENTS

With following examples, the present invention is further explained, but not limited in the range of said examples. The experimental methods without marked with specific condition in following examples, comply with normal methods and conditions, or comply with commodity specification.

The materials related to the present invention are all commercially available:

| item | specification | Supplier |
|---|---|---|
| metal aluminum | average granule | Henan Yuanyang Aluminum Co. |
| | diameter 9~11 μm | Ltd. China, www.hnyyly.com |
| NaAlO₂ | powder, | Guoyao Group Chemical Reagent |
| | chemically pure | Co. Ltd. China, |
| | | www.reagent.com.cn |
| Li—Al alloy | Li20%, Al80%, | Jiangxi Ganfeng Lithium Co. Ltd. |
| | average granule | China, www.ganfenglithium.com |
| | diameter 0.07~0.15 mm | |
| Li₂O | powder, purity | Jiangxi Ganfeng Lithium Co. Ltd. |
| | 98.5% | China, www.ganfenglithium.com |
| KOH | flake, | Shanghai Chemical Reagent Co. |
| | analytically pure | Ltd. Shanghai Plant 1, China. |
| Sr(OH)₂•8H₂O | powder, | Shanghai Xinbao Fine Chemical |
| | analytically pure | Plant, China, www.nicechem.com |
| disposable | 10 ml, plastic | Changzhou Yuekang Medical |
| medical syringe | | Equipment Co. Ltd. China, |
| | | www.yuekang.com.cn |
| flexible material, | cell closed, | Shanghai Zhengyang Foamed |
| flexurane foamed | specific weight | Plastic Co. Ltd. China, |
| plastic sheet, high | 0.12, thickness | www.zy-pu.com |
| temperature | 2.5 mm, cell | |
| withstand | density 80PPI | |
| modified | | |
| filtration material, | cell opened, | Shanghai Zhengyang Foamed |
| flexurane foamed | specific weight | Plastic Co. Ltd. China, |
| plastic, high | 0.06, cell density | www.zy-pu.com |
| temperature | 80PPI | |
| withstand | | |
| modified | | |
| Na₂SiO₃ | purity 97%, since | Qingdao Dongyue Sodium Silicate Co. |
| | the granule is | Ltd. China, www.qssf.com |
| | quite rough, | |
| | prepare by screen | |
| | 200 mesh, | |
| | reserve the | |
| | dropped | |
| Na₄SiO₄(2Na₂O•SiO₂) | purity >87%, | Qingdao Dongyue Sodium Silicate Co. |
| | 80% of the | Ltd. China, www.qssf.com |
| | granule between | |
| | 20 to 100 mesh | |

The common points of all the examples:

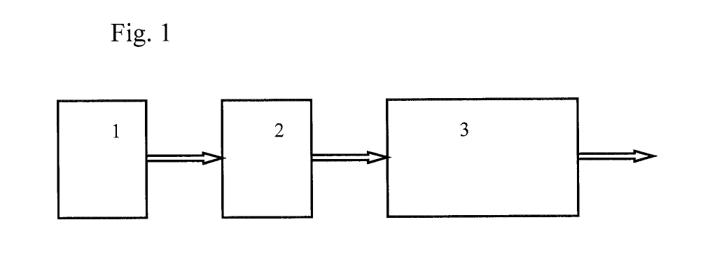

In all the examples hereinafter, a beaker containing water is the liquid vessel 1; a peristaltic pump is the liquid pump 2; a disposable medical syringe comprising said composition is the reactor 3; refer to FIG. 1.

Add water to the collection of reactants with the peristaltic pump, the flow rate of peristaltic pump during operation is 0.02 g/min; example 4 is the only exception with less flow rate.

The average granule diameter of metal aluminum is 9˜11 μm.

The enclosure of 10 ml disposable medical syringe serves as the enclosure of reactor. The syringe needle is not applied; the port on enclosure for connecting the syringe needle serves as water inlet, and is connected to the water outlet of peristaltic pump. Pull out the push rod, take down the rubber piston on it, and then fill it in the original inlet of said push rod, so that it serves as the sealing plug of gas outlet. A pore is opened in the center of rubber piston, and serves as the gas outlet for hydrogen.

The flexible material, flexurane foamed plastic sheet, is cut and rolled to a cylinder, outer diameter 15 mm, inner diameter 10 mm, length 65 mm, and then filled into the reactor enclosure, close to the water inlet. Only the example 5 is an exception.

Fill the collection of reactants into said flexible material cylinder, close to the water inlet; then cut the filtration material, flexurane foaming plastic, fill it into the flexible material cylinder, supporting the collection of reactants.

During the reaction progress, said reactor is vertically placed, with the water inlet upward, and the gas outlet downward.

The method of measuring hydrogen yield is water volume pushed out.

The environment is room temperature. The reactor is placed in environment air, only except partial time of contrasting example 2 and 3, as well whole time of example 4.

During the reaction process, a portion of water absorbs the reaction heat and evaporates to steam, then flows out with hydrogen. Thus, the flow rate of water added is not in strict ratio to the hydrogen produced.

### Example 1

Mechanically mix 1.25 g Li20%-Al80% alloy with 1.7 g metal aluminum, as the collection of reactants. Wherein the content of Li is 0.25 g, about 0.036 Mol; the content of metal aluminum is 2.7 g, about 0.1 Mol. The effective molar ratio of alkaline substance with respect to metal aluminum is 0.036/0.1=0.36.

After accumulative 8.5 hours running of the peristaltic pump, the hydrogen producing rate remarkably drops, experiment end. Accumulative 3.4 L hydrogen is collected. In theoretical calculation, 0.25 g Li should produce about 0.4 L hydrogen, 2.7 g metal aluminum should produce about 3.36 L hydrogen, totally 3.76 L. So the hydrogen yield is 90.4% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.2 L hydrogen is collected, corresponding to about 0.018 Mol water, and has a molar ratio of 0.18 with respect to the 0.1 Mol metal aluminum initially added.

### Example 2

Mechanically mix 0.3 g NaAlO₂ with 2.7 g metal aluminum, as the collection of reactants. Since NaAlO₂ is not certainly 100% ionized while solved in water, so the effective molar value is ≦0.0037, the effective molar ratio with respect to metal aluminum is ≦0.037.

After accumulative 6.5 hours running of the peristaltic pump, the hydrogen producing rate remarkably drops, experiment end. Accumulative 3.09 L hydrogen is collected. In theoretical calculation, 2.7 g metal aluminum should produce about 3.36 L hydrogen. So the hydrogen yield is about 92% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.3 L hydrogen is collected, corresponding to about 0.027 Mol water, and has a molar ratio of 0.27 with respect to the 0.1 Mol metal aluminum initially added.

In the restart after said suspended 8 hours, the peristaltic pump runs only 5 minutes, then suspends 8 hours once again, and restarts once again. At the end of suspended 8 hours once again, the flow rate of hydrogen output drops to nearly 0, so can't be observed. In the suspended 8 hours once again, about 10 mL hydrogen is collected, corresponding to about 0.0009 Mol water, and has a molar ratio of 0.009 with respect to the 0.1 Mol metal aluminum initially added.

### Example 3

Place 0.6 g NaAlO₂ in the reactor where close to the water inlet, place 2.7 g metal aluminum in the reactor where close to the NaAlO₂ but away from the water inlet. Respect to the fluid flow direction, the alkaline substance is placed in the upper reaches, the metal aluminum is placed in the lower reaches, so the collection of reactants is formed. Since NaAlO₂ is not certainly 100% ionized while solved in water, so the effective molar value is ≦0.0073, the effective molar ratio with respect to metal aluminum is ≦0.073.

After accumulative 7 hours running of the peristaltic pump, the hydrogen producing rate remarkably drops, experiment end. In the beginning 0.5 hour, the hydrogen producing rate is very low, and then gradually rises to normal. Accumulative 2.62 L hydrogen is collected. In theoretical calculation, 2.7 g metal aluminum should produce about 3.36 L hydrogen. So the hydrogen yield is about 78% of theoretical limitation.

After 5 hours running of the peristaltic pump, it is suspended for 8 hours, and then restarted. At the end of suspended 8 hours, the flow rate of hydrogen output drops to nearly 0, so can't be observed. In the suspended 8 hours, about 0.25 L hydrogen is collected, corresponding to about 0.022 Mol water, and has a molar ratio of 0.22 with respect to the 0.1 Mol metal aluminum initially added.

### Example 4

Mechanically mix 0.025 g NaAlO₂ with 2.7 g metal aluminum, as the collection of reactants. Since NaAlO₂ is not certainly 100% ionized while solved in water, so the effective molar value is ≦0.0003, the effective molar ratio with respect to metal aluminum is ≦0.003.

During all of the reaction time, the reactor is immerged in 40° C. warm water.

The flow rate of peristaltic pump is 0.005 g/min. Record the hydrogen yield in time intervals of 3 hours. In the first 3 hours, 510 ml is collected; in the second 3 hours, 470 ml is collected; in the 3 hours, 360 ml is collected. Even though the flow rate of peristaltic pump is constant, but the flow rate of hydrogen is continuously dropping, so experiment end.

Accumulative 1.34 L hydrogen is collected. In theoretical calculation, 2.7 g metal aluminum should produce about 3.36 L hydrogen. So the hydrogen yield is about 39.9% of theoretical limitation.

### Example 5

Mechanically mix 0.3 g NaAlO₂ with 2.7 g metal aluminum, as the collection of reactants. Since NaAlO₂ is not certainly 100% ionized while solved in water, so the effective molar value is ≦0.0037, the effective molar ratio with respect to metal aluminum is ≦0.037.

Then further mixes in said polypropylene foamed plastic granules of stacking volume 5 cc, repeatedly shakes in a small plastic bottle with cap for even mixing, results in a stacking volume 6 cc after filled in the reactor. No cylindrical flexurane foaming plastic is used.

After accumulative 6 hours running of the peristaltic pump, the hydrogen producing rate remarkably drops, experiment end. Accumulative 2.81 L hydrogen is collected. In theoretical calculation, 2.7 g metal aluminum should produce about 3.36 L hydrogen. So the hydrogen yield is about 83.6% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.15 L hydrogen is collected, corresponding to about 0.0135 Mol water, and has a molar ratio of 0.135 with respect to the 0.1 Mol metal aluminum initially added.

The inventor speculates in theory, the reason that the yield of this example is worse than example 2, is perhaps that the unregulated shape of polypropylene foamed plastic granules impedes the diffusion of liquid phase; the reason that the residual water in reaction suspension of this example is less than example 2, is perhaps the good hydrophobicity of polypropylene foamed plastic. The less residual water in reaction suspension is helpful to reduce the buffer for storing residual produced hydrogen in application systems.

### Example 6

Mechanically mix 0.6 g Na₂SiO₃ with 2.7 g metal aluminum, as the collection of reactants. Since Na₂SiO₃ is not certainly 100% ionized while solved in water, as well considering its chemical valence 2, also considering the purity, so the effective molar value is ≦0.0095, the effective molar ratio with respect to metal aluminum is ≦0.095.

After accumulative 6.5 hours running of the peristaltic pump, the hydrogen producing rate remarkably drops, experiment end. Accumulative 2.55 L hydrogen is collected. In theoretical calculation, 2.7 g metal aluminum should produce about 3.36 L hydrogen. So the hydrogen yield is about 75.9% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.1 L hydrogen is collected, corresponding to about 0.009 Mol water, and has a molar ratio of 0.09 with respect to the 0.1 Mol metal aluminum initially added.

### Example 7

Mechanically mix 0.6 g Na₄SiO₄ with 2.7 g metal aluminum, as the collection of reactants. Since Na₄SiO₄ is not certainly 100% ionized while solved in water, as well considering its chemical valence 4, also considering the purity, so the effective molar value is ≦0.0113, the effective molar ratio with respect to metal aluminum is ≦0.113.

After accumulative 6 hours running of the peristaltic pump, the hydrogen producing rate remarkably drops, experiment end. Accumulative 2.57 L hydrogen is collected. In theoretical calculation, 2.7 g metal aluminum should produce about 3.36 L hydrogen. So the hydrogen yield is about 76.5% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.2 L hydrogen is collected, corresponding to about 0.018 Mol water, and has a molar ratio of 0.18 with respect to the 0.1 Mol metal aluminum initially added.

### Example 8

Mechanically mix 6 g NaAlO₂ with 2.7 g metal aluminum, as the collection of reactants. Since NaAlO₂ is not certainly 100% ionized while solved in water, so the effective molar value is ≦0.074, the effective molar ratio with respect to metal aluminum is ≦0.74.

After accumulative 6 hours running of the peristaltic pump, the hydrogen producing rate remarkably drops, experiment end. Accumulative 3.15 L hydrogen is collected. In theoretical calculation, 2.7 g metal aluminum should produce about 3.36 L hydrogen. So the hydrogen yield is about 94% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.15 L hydrogen is collected, corresponding to about 0.0135 Mol water, and has a molar ratio of 0.135 with respect to the 0.1 Mol metal aluminum initially added.

### Example 9

Mechanically mix 0.12 g NaAlO₂ with 2.7 g metal aluminum, as the collection of reactants. Since NaAlO₂ is not certainly 100% ionized while solved in water, so the effective molar value is ≦0.0015, the effective molar ratio with respect to metal aluminum is ≦0.015.

After accumulative 6 hours running of the peristaltic pump, the hydrogen producing rate remarkably drops, experiment end. Accumulative 2.8 L hydrogen is collected. In theoretical calculation, 2.7 g metal aluminum should produce about 3.36 L hydrogen. So the hydrogen yield is about 83% of theoretical limitation.

After 2 hours running of the peristaltic pump, it is suspended for 8 hours, and then restarted. At the end of suspended 8 hours, the flow rate of hydrogen output drops to nearly 0, so can't be observed. In the suspended 8 hours, about 0.3 L hydrogen is collected, corresponding to about 0.027 Mol water, and has a molar ratio of 0.27 with respect to the 0.1 Mol metal aluminum initially added.

### Example 10

In this example, the inventor tests the result of a special combination, using the composition of present invention, while not fully using the method of present invention, adding excess water.

In this case, the normally used disposable medical syringe with compact structure can't contain the excess water, and may let the water solving alkaline substance brought out by hydrogen flow, thereby affect the stability of composition. Thus a 50 cc plastic beaker serves as the reactor, and assistant sealing measure is taken to collect hydrogen. Since the space is greater, the flexible material is not needed. The environment is still room temperature. The composition is same to example 2.

With the interval of 10 minutes, inject 0.5 g water per time into said plastic beaker using a manual syringe. Every time, it reacts quickly and output hydrogen, then after 2˜4 min, rapidly drops the producing rate to nearly can't be observed, the hydrogen yield is about 0.15 L. After 12 times, the accumulative hydrogen yield is 1.8 L.

Thereafter, quickly inject 2.5 g water, which has a molar ratio of 1.38, with respect to the 0.1 Mol metal aluminum initially added. Quick reaction doesn't happen again; instead, it very slowly output hydrogen, and yield only 0.11 L in 1 hour; the producing rate further continuously drops, and yield only 0.24 L in following 8 hours; but the reaction doesn't stop, and is still producing hydrogen in a very low rate.

The inventor analyzes in theory, believes that the excess water dilutes the alkaline substance, thereby makes the reaction rate very low; meantime, the excess water also increases the heat capacity of system, in case of very low reaction rate, it's more difficult to rise the temperature with reaction heat and accelerate the reaction. Thus the system drops into negative balance.

On the other hand, this proves the safety of the composition in case it leaks and be washed with excess water.

### Contrasting Example 1

Mechanically mix 0.3 g Li₂O with 2.7 g metal aluminum, as the collection of reactants. For per Mol Li₂O solved in enough water, 2 Mol hydroxy is produced; so the effective molar value is 0.02, the effective molar ratio with respect to metal aluminum is 0.2.

After accumulative 6.5 hours running of the peristaltic pump, the hydrogen producing rate remarkably drops, experiment end. Accumulative 2.53 L hydrogen is collected. In theoretical calculation, 2.7 g metal aluminum should produce about 3.36 L hydrogen. So the hydrogen yield is about 75.3% of theoretical limitation.

After 5 hours running of the peristaltic pump, it is suspended for 8 hours, and then restarted. At the end of suspended 8 hours, the flow rate of hydrogen output drops to nearly 0, so can't be observed. In the suspended 8 hours, about 0.35 L hydrogen is collected, corresponding to about 0.031 Mol water, and has a molar ratio of 0.31 with respect to the 0.1 Mol metal aluminum initially added.

In this example, even though the weight of alkaline substance is same to example 2 of the present invention, but the yield percentage is far lower, also the market price of Li₂O is relatively high; as well Li₂O reacts with water and produces LiOH, which is relatively corrosive, not environmentally friendly enough.

### Contrasting Example 2

Mechanically mix 0.3 g KOH with 2.7 g metal aluminum, as the collection of reactants. The effective molar value of KOH is 0.0054, so the effective molar ratio with respect to metal aluminum is 0.054.

The commercially available KOH is normally sheet type, if it is not broken enough during the mechanical mixing process, high temperature point will occur in reaction process, and burns through the enclosure of reactor. Thus 2 measures are both taken: A, tries best to break it during mechanical mixing of KOH and metal aluminum; B, immerge the reactor in 60° C. water in the first 1 hour of reaction; Then place it in room temperature air in the following time of reaction, such as other examples.

After accumulative 6.5 hours running of the peristaltic pump, the hydrogen producing rate remarkably drops, experiment end. Accumulative 2.85 L hydrogen is collected. In theoretical calculation, 2.7 g metal aluminum should produce about 3.36 L hydrogen. So the hydrogen yield is about 84.8% of theoretical limitation.

After 3 hours running of the peristaltic pump, it is suspended for 8 hours, and then restarted. At the end of suspended 8 hours, the flow rate of hydrogen output drops to nearly 0, so can't be observed. In the suspended 8 hours, about 0.25 L hydrogen is collected, corresponding to about 0.022 Mol water, and has a molar ratio of 0.22 with respect to the 0.1 Mol metal aluminum initially added.

For this example, in order to prevent the reactor enclosure from burning through, it has to been immerged in water and limits the temperature rise thereof. In real application, if it is necessary to limit the temperature of enclosure, or to use high temperature resistant enclosure, the cost/weight/volume of system will inevitably remarkably increase. In small possibility case, the air remaining in the reactor will mix with hydrogen produced and may be ignited by high temperature point. Also, the safety and environmental protection of KOH are bad.

### Contrasting Example 3

Mechanically mix 3.3 g Sr(OH)₂.8H₂O with 2.7 g metal aluminum, as the collection of reactants. For per Mol Sr(OH)₂.8H₂O solved in enough water, 2 Mol hydroxy is produced; so the effective molar value is 0.025, the effective molar ratio with respect to metal aluminum is 0.25.

After accumulative 6 hours running of the peristaltic pump, the hydrogen producing rate remarkably drops, experiment end. In the last 2 hours, the reaction is quite week, the reactor is immerged in 60° C. water, so as to improve slightly. Accumulative 2.51 L hydrogen is collected. In theoretical calculation, 2.7 g metal aluminum should produce about 3.36 L hydrogen. So the hydrogen yield is about 74.7% of theoretical limitation.

After 4 hours running of the peristaltic pump, it is suspended for 8 hours, and then restarted. At the end of suspended 8 hours, the flow rate of hydrogen output drops to nearly 0, so can't be observed. In the suspended 8 hours, about 0.2 L hydrogen is collected, corresponding to about 0.018 Mol water, and has a molar ratio of 0.18 with respect to the 0.1 Mol metal aluminum initially added.

In this example, the weight of Sr(OH)₂. 8H₂O is far more than example 2 of the present invention, but the hydrogen yield is far lower even with the help of hot water. In real application, the energy density will be very low, the cost will be greater, and the wastage on aluminum will be severe. Even if replace Sr(OH)2.8H2O with SrO in same molar value, the weight and coat are still remarkable; also, in theoretical speculation, it will absorb crystalline water and become heavier in reaction.

The simple variations well known by the skilled personnel of this field are all protected by the present invention.

For example, the skilled personnel of this field, may only place metal aluminum in the reactor, but add an additional vessel between water source and reactor to store the alkaline substance; when the water flow passes, the alkaline substance is solved and brought to the reactor and reacts with metal aluminum. This embodiment makes the system complicated, and the concentration of alkaline substance too concentrated, thus is not preferred. But this is very close to example 6, so obviously protected by the present invention.

Also, the skilled personnel of this field, may place excess alkaline substance in said vessel for storing thereof, but the portion solved by water and brought to mass-transferring contact with metal aluminum, still has an effective molar ratio of less than 0.8; the portion remaining in said vessel, may be used in next time. This embodiment makes the system maintenance procedure complicated, needs to replace metal aluminum and supply alkaline substance in different time interval, and thus is not preferred. But this obviously doesn't escape from the feature B of claim 8.

1-17. (canceled)

18. A composition, wherein it comprises alkaline substance and metal aluminum;
wherein said alkaline substance is the salt of alkali metal and weak acid, the effective molar ratio of the alkaline substance with respect to the metal aluminum is less than 0.8, but greater than 0;
said effective molar ratio, is calculated with the hydroxy ion produced by the alkaline substance or its reaction product with water while solving in enough water, with respect to the metal aluminum;
said alkali metal is Li, Na or K;
said weak acid is meta-aluminic acid.

19. The composition of claim 18, wherein said effective molar ratio of the alkaline substance with respect to the metal aluminum is less than 0.8, but greater than 0.001.

20. The composition of claim 19, wherein said effective molar ratio of the alkaline substance with respect to the metal aluminum is less than 0.4, but greater than 0.01.

21. The composition of claim 18, wherein said metal aluminum is granular, with average diameter less than 0.1 mm.

22. A method for the preparation of hydrogen, suitable for civil applications, in which metal aluminum is mainly used for producing hydrogen; wherein:
A. Water is added into a collection of reactants formed by placing alkaline substance and metal aluminum together;
B. The portion of said alkaline substance or its reaction product with water, wherein participates in the mass-transferring contact with said metal aluminum, has an effective molar ratio of less than 0.8 with respect to said metal aluminum;
said effective molar ratio, is calculated with the hydroxy ion produced by the alkaline substance or its reaction product with water while solving in enough water;
C. During the reaction, residual reactive but as yet unreacted water has a molar ratio of less than 1 but greater than 0 with respect to the metal aluminum added initially;
wherein, the type of alkaline substance and metal aluminum is described in claim 18.

23. The method of claim 22, wherein metal aluminum is mainly used for producing hydrogen; wherein:
A. Water is added into a composition wherein it comprises alkaline substance and metal aluminum;
wherein said alkaline substance is the salt of alkali metal and weak acid, the effective molar ratio of the alkaline substance with respect to the metal aluminum is less than 0.8, but greater than 0;
said effective molar ratio, is calculated with the hydroxy ion produced by the alkaline substance or its reaction product with water while solving in enough water, with respect to the metal aluminum;
B. During the reaction, residual reactive but as yet unreacted water has a molar ratio of less than 1 but greater than 0 with respect to the metal aluminum added initially.

24. The method of claim 22, wherein during the reaction, residual reactive but as yet unreacted water has a molar ratio of less than 0.5 with respect to the metal aluminum added initially.

25. The method of claim 22, wherein in said collection of reactants formed by placing alkaline substance and metal aluminum together, said alkaline substance and said metal aluminum are placed in a common fluid channel;
respect to the fluid flow direction, the alkaline substance is placed in the upper reaches, the metal aluminum is placed in the lower reaches.

26. A reactor, wherein it comprises said composition from claim 18.

27. The reactor of claim 26, wherein said reactor further comprises a flexible material, which is placed in the reactor together with the composition.

28. The reactor of claim 27, wherein said composition is cylindrically surrounded by said flexible material;
and/or, said flexible material is foamed polypropylene plastic.

29. The reactor of claim 26, wherein the alkaline substance and the metal aluminum in said composition are placed in a common fluid channel;
respect to the fluid flow direction, the alkaline substance is placed in the upper reaches, the metal aluminum is placed in the lower reaches;
wherein, the reactor comprises 2 solid vessels joining each other, the 2 solid vessels comprise the alkaline substance and metal aluminum of said composition respectively;
respect to the fluid flow direction, the solid vessel comprising alkaline substance is placed in the upper reaches, the solid vessel comprising metal aluminum is placed in the lower reaches;
and/or, said reactor is equipped with a dismountable connector, which can be used to join the matching connector from other device;
and/or, said reactor is equipped with a fluid inlet, which can accept fluid to flow into the reactor.

30. A reaction device for the preparation of hydrogen, comprising said reactor from claim 26, and a liquid vessel;
the reactor and the liquid vessel connect each other, the liquid vessel contains water.

31. The reaction device of claim 30, wherein said reactor and said liquid vessel are connected through a liquid pump.
